(19) United States
(12) Patent Application Publication
(10) Pub. No.: US 2014/0375202 A1
(43) Pub. Date: Dec. 25, 2014

(54) LED BULB

(71) Applicant: UniLED Lighting TW., Inc., New Taipei City (TW)

(72) Inventors: Po-Cheng YANG, New Taipei City (TW); Ming-Yao LIN, New Taipei City (TW); Heng QIU, Kaohsiung (TW)

(21) Appl. No.: 13/926,676

(22) Filed: Jun. 25, 2013

(51) Int. Cl. F21V 29/00

(52) U.S. Cl. CPC F21V 29/004
USPC 313/36

(57) ABSTRACT

A high heat dissipation efficiency light emitted diode (LED) bulb is disclosed, a plurality of metal plate configured side by side to form a circular metal wall, light unit is mounted on top end of the metal plate. A side opening is made on a bottom of selected metal plate. A glass bulb encloses the metal plate and the light unit hermetically. A gas with a thermal conductivity higher than that of air, such as Helium gas, is filled in the glass bulb for an internal circulation and heat dissipation of the bulb.

### BACKGROUND

1. Technical Field

The present invention relates to a light emitted diode (LED) bulb, especially to an LED bulb filled with a gas which has a thermal conductivity higher than that of air, such as Helium gas, with which the LED bulb displays good heat dissipation capability.

2. Description of Related Art

FIG. 1 is a prior art

FIG. 1 is a publication version of US 2003/0031015 which shows a traditional LED lamp. A printed circuit board 5 has a plurality of belt-like branches 5a extending in radial directions from the center stop 4. A plurality of LED chip 6 is mounted on the circuit board 5. A transparent cover 2 encloses the circuit board 5 and the LED chip 6. A supporting rod 3 is used for the mounting of the circuit board 5. A pair of stops 4 is used for fixing the position of the circuit board 5 on the supporting rod 3. A power source housing 8 is configured on a top of the transparent bulb 2 for AC to DC power conversion before supplying the power to the LED 6 of the bulb. A lamp base 1 is configured on a top of the power source housing 8 for mounting the bulb into a traditional lamp socket. The deficiency of the traditional LED lamp is to give high heat, the high heat not only decreases the power efficiency but also decreases the lifetime of the lamp. An LED lamp with high heat dissipation capability is desired nowadays.

### BRIEF DESCRIPTION OF THE DRAWINGS

FIG. 1 is a prior art

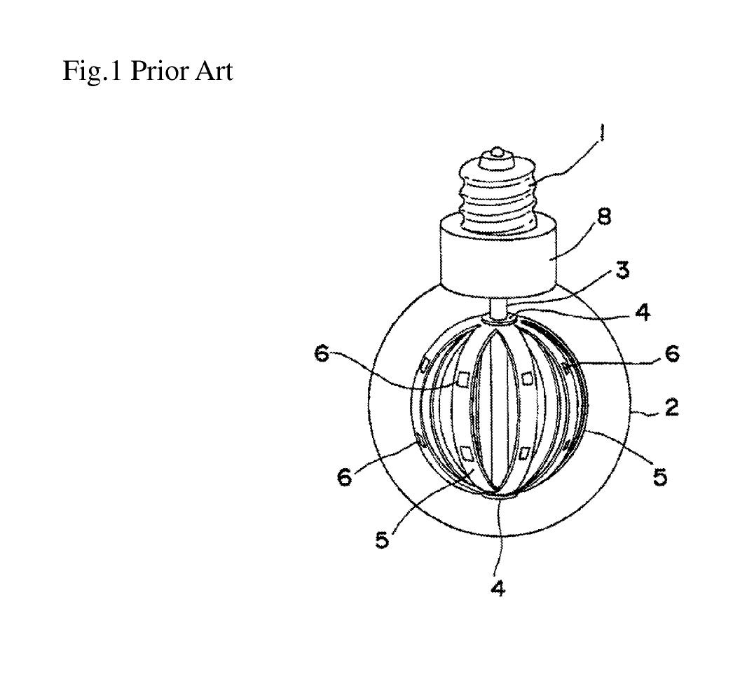

FIG. 2 is a first embodiment according to the present invention.

FIG. 3 is a section view of FIG. 2.

FIG. 4 is a second embodiment according to the present invention

FIG. 5 is a section view of FIG. 4

FIG. 6 is a third embodiment according to the present invention

FIG. 7 is a fourth embodiment according to the present invention

### DETAILED DESCRIPTION OF THE INVENTION

The present invention discloses a high heat dissipation LED lamp bulb with a helium gas filled in the LED bulb. An internal circulation is also enabled for homogenizing the inner temperature of the helium gas inside the bulb. A thermal conductivity for air is 0.024 W·m⁻¹·K⁻¹ while a thermal conductivity for helium is 0.1513·m⁻¹. K⁻¹ which is 6.3 times than that for air. The higher thermal conductivity for helium helps heat transfer efficiently from inside to outside of the LED bulb. The helium gas filled LED bulb of the present invention is manifested to have a temperature of 105 degree Celsius, in contrast to a temperature of 132 degree Celsius where air is filled in the same LED bulb.

Except helium gas, additional gas which has a thermal conductivity higher than that of the air is Hydrogen, Nitrogen, Deuterium, or Neon. The gas filled in the bulb can be a single gas or a mixture of different gases.

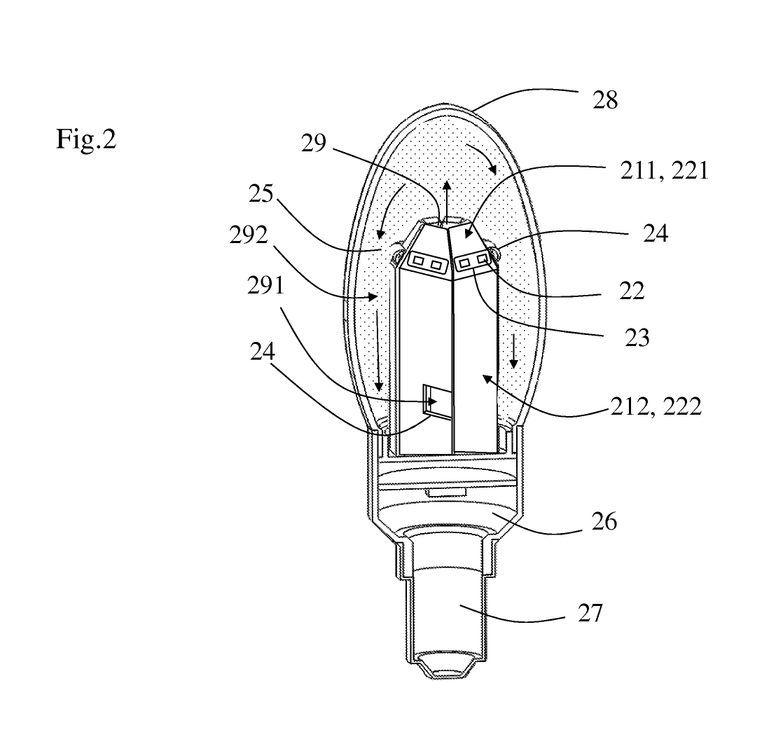

FIG. 2 is a first embodiment according to the present invention.

FIG. 2 shows that an LED bulb having a plurality of first metal plate 211, each first metal plate 211 has a tapered end on top, configured side by side to form a conical metal wall 221. A flexible circuit board 23 is configured on the surface of the first metal plate 211. A plurality of LED chip 22 is mounted on the flexible circuit board 23. The heat generated from the LED chip 22 passes through the flexible circuit board 23 and then transmits to the first metal plate 211 for heat dissipation. The LED chip 22 can be mounted on the metal surface of the first metal plate 211 directly or indirectly in one of several traditional different ways. FIG. 2 is only an example for an indirect mounting for an explaining of the concept which the present invention implies. A top opening 29 is enclosed by the tapered end of the plurality of first metal plate 211. A plurality of second metal plate 212 is configured each on a bottom of one of the plurality of first metal plate 211 to form a circular metal wall 222. A side opening 24 is configured on a bottom of selected second metal plate 212. A transparent bulb 28 encloses hermetically the first metal 211, the LED chip 22, flexible circuit board 23, and the second metal plate 212. A helium gas 25 is filled in the LED bulb 28. An internal circulation of the helium gas 25 occurs when the bulb is energized. An inner area 291 and an outer area 292 are spaced by the first metal plates 211 and the second metal plates 212; in other words, an inner area 291 and an outer area 292 are spaced by the conical metal wall 221 and the circular metal wall 222. The heat generated from the LED chip 22 transmits to the conical metal wall 221 and the circular metal wall 222. The helium gas 25 in the inner area 291 is heated by the conical metal wall 221, the circular metal wall 222, and power electronics (not shown) in the inner area 291. The heated helium gas 25 in the inner area 291 goes upward and enters the outer area 292. The cooler helium gas 25 in the outer area 292 goes downward and passes through the side opening 24 to enter the inner area 291. A neck portion 26 is configured on a bottom of the transparent bulb 28. A lamp base 27 is configured on a bottom of the neck portion 26. Power electronics (not shown) for the LED bulb can be housed in the inner area 291 or the space inside the neck portion 26. The LED chip 22 can be mounted on the surface of the conical metal wall directly or indirectly according to one of several traditional methods.

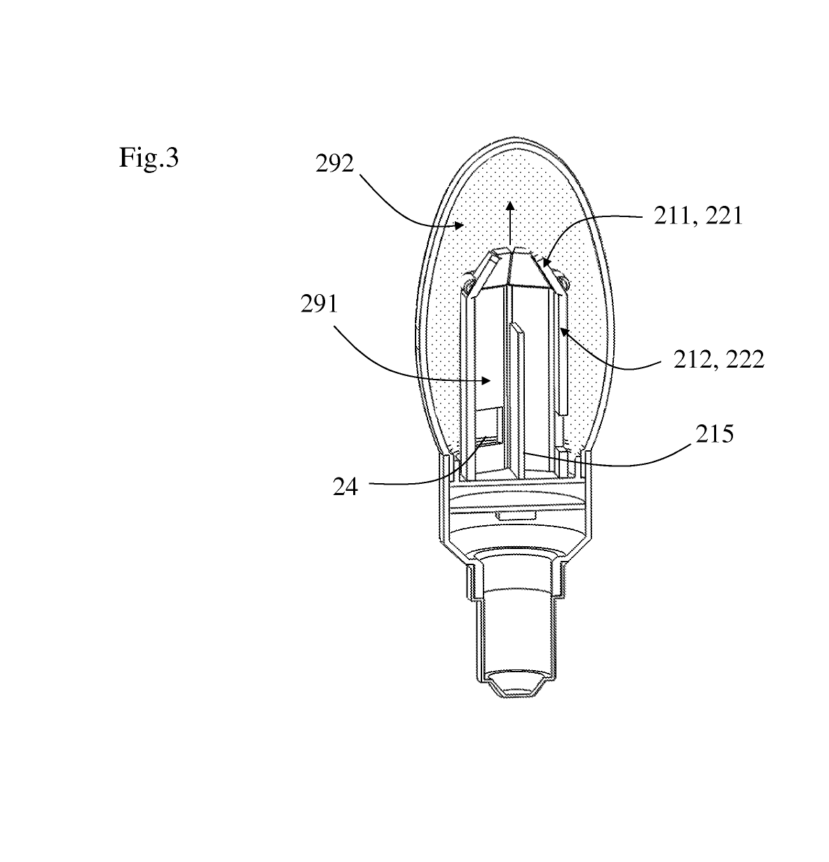

FIG. 3 is a section view of FIG. 2.

FIG. 3 shows that the inner area 291 and the outer area 292 are separated by the conical metal wall 221 and the circular metal wall 222. A circuit board 215 with other electronics (not shown) can be housed in the inner area 291. The heat generated from the electronics can also be carried away by the up-rising helium gas 25 in the inner area 291. The side opening 24 communicates the inner area 291 with the outer area 292 within the LED bulb.

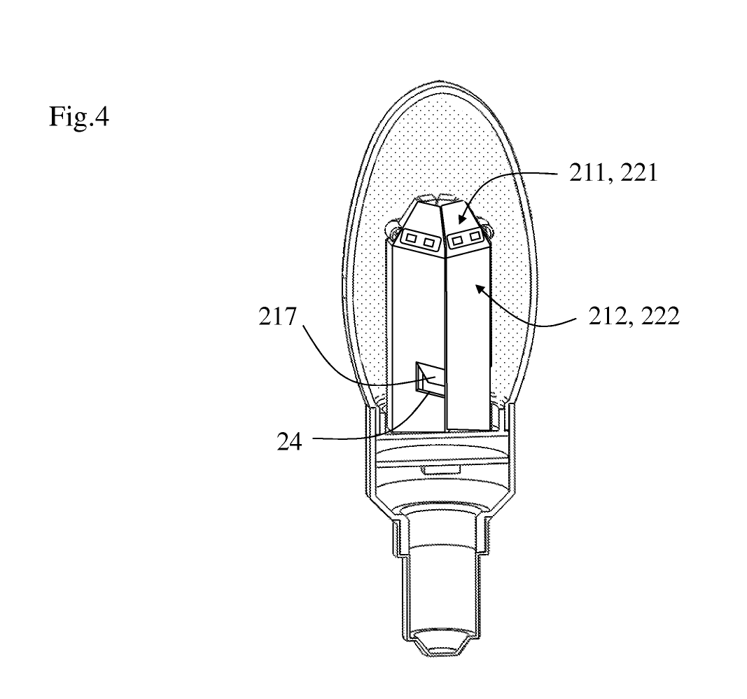

FIG. 4 is a second embodiment according to the present invention

FIG. 4 is similar to that of FIG. 3; the only difference is at the point of the side opening 24. FIG. 4 shows that a metal piece 217 extends from a top edge of the side opening 24, a free end of the metal piece 217 tilts inward. This design simplifies the manufacturing process to form the side opening 24; the metal piece 217 is formed by a U cut on the second metal 212 and pushed inward.

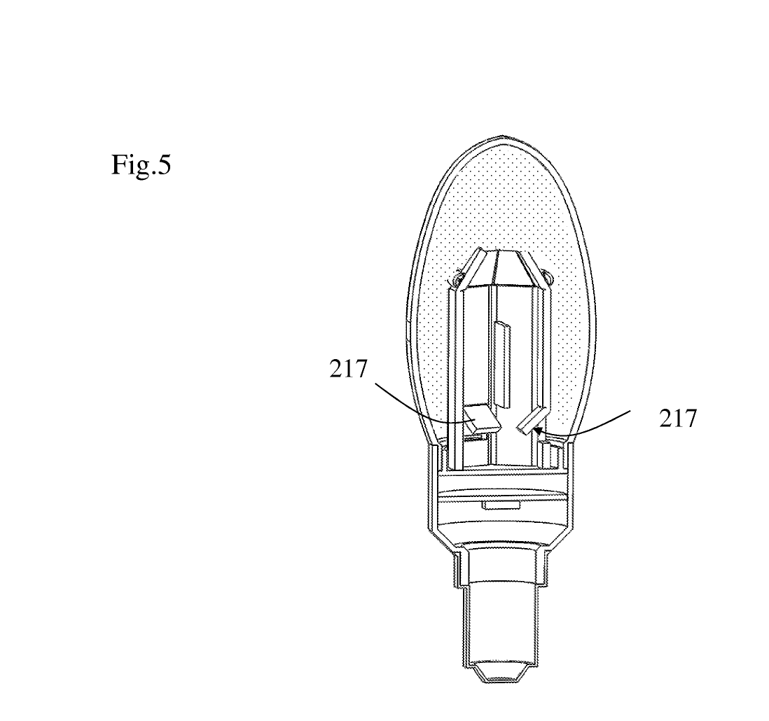

FIG. 5 is a section view of FIG. 4

FIG. 5 shows that the metal piece 217 extends from the top edge of the window 24. The free end of the metal piece 217 is pushed inward.

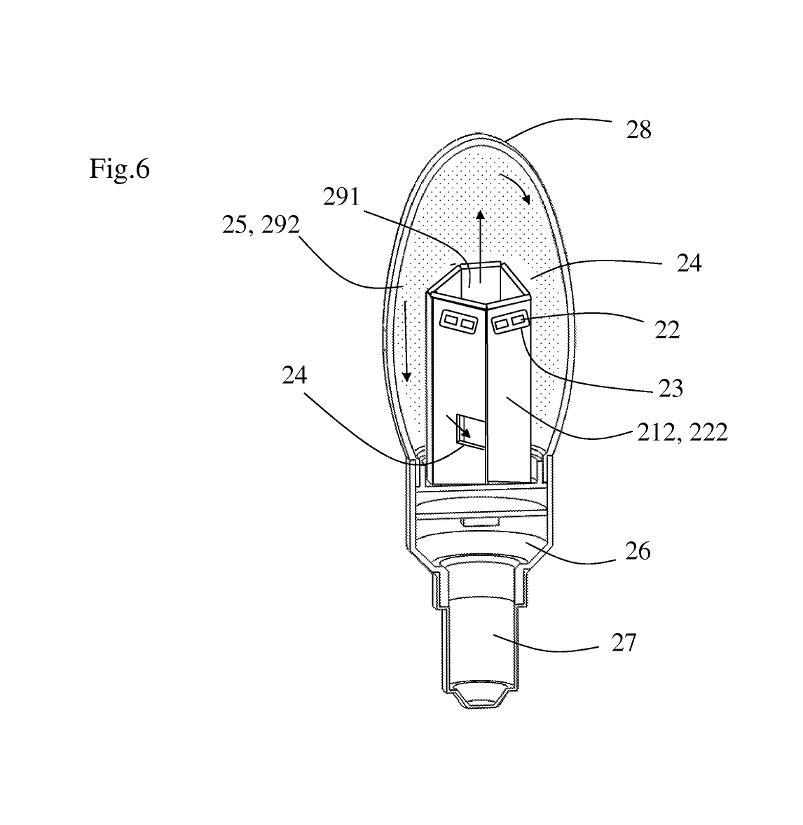

FIG. 6 is a third embodiment according to the present invention

FIG. 6 is similar to that of FIG. 2, the only difference is at the point of the conical metal wall 221. FIG. 6 is a modification version where the conical metal wall 221 of FIG. 2 is omitted. FIG. 6 shows that a plurality of metal plate 212 is configured side by side. In other words, a circular metal wall 222 is formed and enclosed in the LED bulb. A flexible circuit board 23 is mounted on the top end of the metal plate 212. A plurality of LED chip 22 is configured on a top surface of the flexible circuit board 23. A top opening is enclosed by the top end of the plurality of metal plate 212. A side opening 24 is configured on a bottom of selected metal plate 212. A transparent bulb 28 encloses the metal plate 212, the LED chip 22 and the flexible circuit board 23. A helium gas 25 is filled in the LED bulb 28.

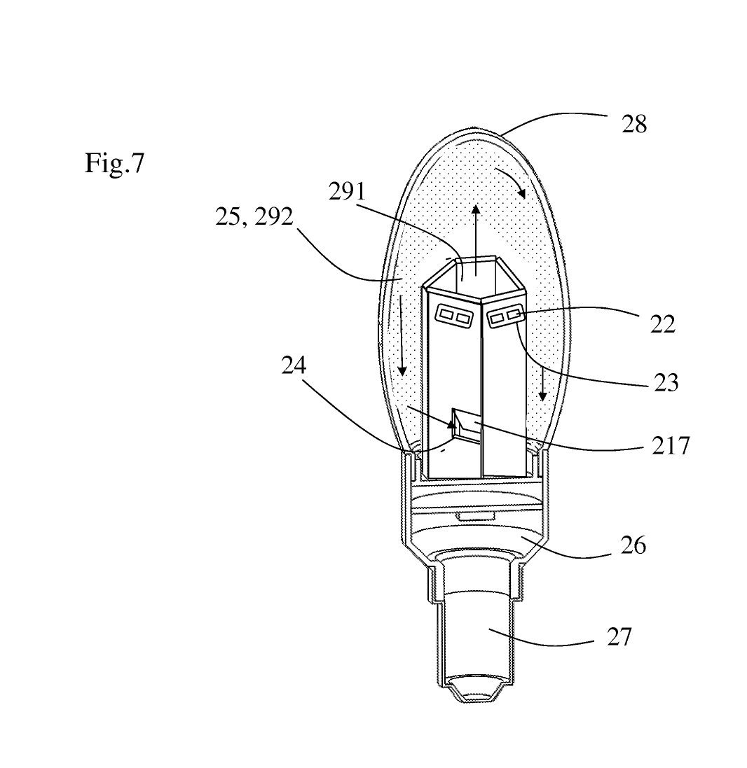

FIG. 7 is a fourth embodiment according to the present invention

FIG. 7 is similar to that of FIG. 6; the only difference is at the point of the side opening 24. A metal piece 217 extends from a top edge of the side opening 24, a free end of the metal piece 217 tilts inward. This design simplifies the manufacturing process of the opening 24; the metal piece 217 is formed by a U cut on the second metal 212 and pushed inward.

While several embodiments have been described by way of example, it will be apparent to those skilled in the art that various modifications may be configured without departing from the spirit of the present invention. Such modifications are all within the scope of the present invention, as defined by the appended claims.

What is claimed is:

1. An LED bulb, comprising:
a conical metal wall, having a top opening;
a light unit, configured on a surface of the conical metal wall;
a circular metal wall, configured on a bottom of the conical metal wall;
a side opening, configured on a bottom of the conical metal wall;
a transparent bulb, enclosing the conical metal wall, the light unit, and the circular metal wall; and
a gas having a higher thermal conductivity than that of air, filled in the bulb.

2. The LED bulb as claimed in claim 1, wherein the conical metal wall further comprising:
a plurality of first metal plate, configured side by side; each of the first metal plate has a tapered top end; and
the circular metal wall, further comprising:
a plurality of second metal plate, configured side by side.

3. The LED bulb as claimed in claim 1, wherein the light unit further comprising:
a flexible circuit board; and
an LED chip, configured on the circuit board.

4. The LED bulb as claimed in claim 1, further comprising:
a metal piece, extended from a top edge of the side opening; and a free end of the metal piece tilted inward.

5. The LED bulb as claimed in claim 1, wherein the gas is selected from the group consisting of Hydrogen, Nitrogen, Deuterium, Helium, and Neon.

6. The LED bulb as claimed in claim 1, wherein the gas is a mixture of ones selected from the group consisting of deuterium, helium, and neon.

7. An LED bulb, comprising:
a circular metal wall, having a top opening;
a light unit, configured on a top surface of the circular metal wall;
a side opening, configured on a bottom of the circular metal wall;
a transparent bulb, enclosing the circular metal wall and the light unit; and
a gas having a higher thermal conductivity than that of air, filled in the bulb.

8. The LED bulb as claimed in claim 7, wherein
the circular metal wall, further comprising:
a plurality of metal plate, configured side by side.

9. The LED bulb as claimed in claim 7, wherein the light unit further comprising:
a flexible circuit board; and
an LED chip, configured on the circuit board.

10. The LED bulb as claimed in claim 7, further comprising:
a metal piece, extended from a top edge of the side opening; and a free end of the metal piece tilted inward.

11. The LED bulb as claimed in claim 7, wherein the gas is selected from the group consisting of Hydrogen, Nitrogen, Deuterium, Helium, and Neon.

12. The LED bulb as claimed in claim 7, wherein the gas is a mixture of ones selected from the group consisting of Hydrogen, Nitrogen, Deuterium, Helium, and Neon.
